(19) United States
(12) Patent Application Publication
(10) Pub. No.: US 2017/0373754 A1
(43) Pub. Date: Dec. 28, 2017

(54) SYSTEM AND METHOD FOR COMMUNICATING WITH DEEP SPACE SPACECRAFT USING SPACED BASED COMMUNICATIONS SYSTEM

(71) Applicant: ESPACESYNERGY, Boulder, CO (US)

(72) Inventors: Wayne Keith DAVIS, Boulder, CO (US); Michael Thomas HACKMAN, Boulder, CO (US)

(73) Assignee: ESPACESYNERGY, Boulder, CO (US)

(21) Appl. No.: 15/633,450

(22) Filed: Jun. 26, 2017

Related U.S. Application Data
(60) Provisional application No. 62/354,965, filed on Jun. 27, 2016.

(51) Int. Cl. H04B 10/112; H04B 10/118; H04B 7/185

(52) U.S. Cl. CPC H04B 10/1123; H04B 7/18515; H04B 10/118

(57) ABSTRACT

A system and method for communicating with deep space spacecraft are provided. A near-Earth space based communications system satellite, which may be deployed in a deep space stable-looking orbit around the Earth, provides two-way communication with the deep space spacecraft, including transmission and reception of commands and data. The near-Earth space based communications system satellite may store data received from the deep space spacecraft and transmits the data to commercial communication satellites and ground terminals. This system and method may be utilized to communicate to the outer planets with a deep-space space based communications system spacecraft at the Earth-Moon Lagrange points, Sun-Earth Lagrange Points, Sun-Mars Lagrange points and extending out to the outer boundary of the solar system. The system and method are further enhanced with the use of free space optical laser communications and x-ray communications to increase data volume from any deep space spacecraft to Earth.

### CROSS REFERENCE TO RELATED APPLICATIONS

The present application claims priority to U.S. Provisional Patent Application Ser. No. 62/354,965, filed Jun. 27, 2016, which is incorporated herein by reference in its entirety.

### FIELD OF THE INVENTION

The present invention relates to a space based communications system for communications with deep space spacecraft, and more particularly to a space based communication system using communication spacecraft placed at strategic locations to communicate with deep space spacecraft.

### BACKGROUND OF THE INVENTION

According to conventional systems, deep space spacecraft communicate directly with large antennas located on Earth. The network that provides this communication for deep space missions from the United States is NASA's Deep Space Network (DSN), which is central to the communication and navigation of deep space missions. Europe and other countries have DSNs similar to NASA's DSN. DSNs provide a two-way communications link for human deep space flights and various unmanned interplanetary space probes to acquire images and other data from the probes.

NASA's DSN include three deep space communication facilities that are located approximately 120° apart from each other to enable consistent communication with deep space spacecraft as the Earth rotates. Each of these facilities includes a plurality of large parabolic antennas for receiving signals from deep space spacecraft. Since deep space spacecraft communicate from locations far from Earth, DSN antennas must have a large aperture in order to be able to receive sufficient energy from signals transmitted by the deep space spacecraft. For example, current DSNs include parabolic antennas as large as 70 meters in diameter.

While nominally supporting the requirements of the past and continuing deep space missions, the current DSN infrastructures are not agile enough to keep pace with the currently increasing number and complexity of civil and commercial deep space spacecraft. Adding to this problem is the return to human deep space flight. Due to the critical nature of human space flight, DSN assets will be dedicated to human space missions, further limiting the availability of the already oversubscribed DSN assets to other deep space spacecraft.

NASA's DSN is a prime example of the challenges Earth based DSN systems are facing. In the March 2015 Office of Inspector General (OIG) audit report on NASA's Management of the Deep Space Network, the OIG points to the challenges and cost of maintaining an aging infrastructure while dealing with the current economic realities of government budget cuts. Compounding this problem is the increasing system demand. According to their own data, NASA's DSN 34-meter High Efficiency (HEF) and Beam Waveguide (BWG) antennas are 20.7% oversubscribed for 2016-2019. To meet budget cuts, NASA is facing the closure of the three HEF antennas, which would create a 25.5% oversubscription. There is additional concern about even being able to continue the current level of service due to budget constraints preventing the needed long-term maintenance for the aging infrastructure.

Within the context of decreasing budgets, government agencies have sought out alternative methods for obtaining the data necessary to support their missions. One alternative method that has gained momentum in the past decade is commercial data buys. Space based communications systems according to the present invention support the commercial data buy framework.

### SUMMARY OF THE INVENTION

The present invention is directed to a near-Earth space based communications system, deep-space space based communications system and space based deep space communication method that facilitates communication with deep space spacecraft without burdening the current DSN infrastructure. The space based communications systems and method uses communication satellites in Geosynchronous Earth Orbit (GEO) and High Elliptical Orbit (HEO) and deep-space spacecraft placed at strategic locations throughout the solar system having large, gimbaled/deployable RF antennas and gimbaled/deployable laser communications systems (lasercom) and/or x-ray communications systems (XCOM). The deep-space system spacecraft may be positioned at Sun to Earth Lagrange points, Earth to Moon Lagrange points, and any other Sun to planet Lagrange points for creating a communication backbone throughout the solar system. The system and method may also place the deep-space system spacecraft having deployable antennas at other strategic locations throughout the solar system and even into deeper areas of space, with the communications satellites being placed in geosynchronous Earth orbits, Equatorial orbits, Tundra or Molniya orbits, other High Elliptical Orbit (HEO), Medium Earth orbits (MEO), or low Earth orbits (LEO).

Near-Earth space based communications systems satellites (communications satellite) that communicate with deep space spacecraft may be provided in deep space stable-looking orbits around the Earth, or with deep-space space based communications systems spacecraft in strategic locations throughout the solar system to operate as relay stations between deep-space spacecraft and Earth. Both the satellite and spacecraft styles may include gimbaled/deployable antennas, gimbaled/deployable lasercom, and/or x-ray communication (XCOM), and other inclusive communications equipment, including, but not limited to separate low noise amplifiers (LNAs), transmitters, and receivers for communicating with one or more deep space spacecraft. By placing the antennas outside of Earth's atmosphere and being capable of performing long periods of communication contact, smaller communications antennas than those used on Earth in DSNs can be used. Signals received by the system specific spacecraft from the deep space spacecraft can be stored in the spacecraft's on-board storage system. Data from the signals received by the deep-space system spacecraft from a deep space spacecraft or deep-space system spacecraft can be stored in the spacecraft's on-board storage system. No processing would need to be performed on the received data before storage. When data is received from a deep space spacecraft or a deep-space system spacecraft (communications satellite) at a near-Earth or Earth-orbiting system satellite, the stored signals can then be wrapped in the communications satellite provider's currently used encoding scheme and be burst transmitted directly to existing ground based communications systems for distribution to the end user.

Data from deep space spacecraft can therefore be retrieved and downlinked for processing and storage without using a DSN. Thus, additional data from deep space spacecraft can be obtained while reducing the burden on DSNs. Consequently, this allows for a greater number of deep space missions and increases the retrieval of images and other data from deep space missions through increased contact periods outside those provided by ground antennas. Also, this allows for backward compatibility with older deep space spacecraft currently on-station or with new, low cost spacecraft that may normally operate at lower data rates or lower periods of contact to a DSN.

### BRIEF DESCRIPTION OF THE DRAWINGS

FIG. 1 illustrates a sample of available orbits around the Earth.

FIG. 2 illustrates near-Earth space based communications system satellites (communications satellite) orbiting Earth communicating with deep space spacecraft and to Earth ground stations.

FIG. 3 illustrates deep-space space based communications system spacecraft placed at strategic locations throughout the solar system communicating with deep space spacecraft.

FIG. 4 illustrates a double gimbaled/deployable reflector antenna with multiple feeds, gimbaled/deployable lasercom and/or XCOM and associated hardware to communicate with a deep space spacecraft in a GEO or near-Earth orbit on a near-Earth space based communications system satellite.

FIG. 5 illustrates a double gimbaled/deployable reflector antenna with multiple feeds, gimbaled/deployable lasercom and/or XCOM and associated hardware to communicate with a deep space spacecraft placed at strategic locations throughout the solar system deep-space space based communications system spacecraft.

FIG. 6 illustrates a single deployable reflector with multiple feeds and associated hardware to communicate with a deep space spacecraft. FIG. 6 also illustrates lasercom and XCOM and associated hardware to communicate with a deep space spacecraft.

FIG. 7 illustrates a method of receiving a communication from a deep space spacecraft and transmitting the communication to a satellite or ground terminal.

FIG. 8 illustrates locations for deep-space space based communications system spacecraft that communicate with deep space spacecraft from Earth-Moon Lagrange points.

FIG. 9 illustrates locations for deep-space space based communications system spacecraft that communicate with deep space spacecraft from Sun-Earth Lagrange points and from a deep-space space based communications system spacecraft in a Sun-centered, Earth leading heliocentric orbit that is relatively stationary with respect to Earth at approximately 18.3 Mkm from Earth.

FIG. 10 illustrates locations for deep-space space based communications system spacecraft that communicate with deep space spacecraft from Sun-Mars Lagrange points and from a deep-space space based communications system spacecraft in a Sun-centered, Mars leading heliocentric orbit that is relatively stationary with respect to Mars at approximately 24.5 Mkm from Mars. Sun-Mars L4 and L5 Lagrange points can be used with care since these points are known to contain Trojan asteroids.

FIG. 11 illustrates locations for deep-space space based communications system spacecraft that communicate with deep space spacecraft from Sun-Jupiter Lagrange points and from a deep-space space based communications system spacecraft in a Sun-centered, Jupiter leading heliocentric orbit that is relatively stationary with respect to Jupiter at approximately 59.2 Mkm from Jupiter. Sun-Jupiter L4 and L5 Lagrange points can be used with care since these points are known to contain Trojan asteroids.

FIG. 12 illustrates a halo orbit that would be used at the Sun-Earth L1 or L2 Lagrange points for a deep-space space based communications system spacecraft station keeping.

FIG. 13 illustrates a large amplitude halo orbit that would be used at the Sun-Earth L3, Sun-Mars or Sun-Jupiter L1, L2 or L3 Lagrange points for a deep-space space based communications system spacecraft station keeping. The large amplitude halo orbit may be larger than that shown depending on the specific location.

### DETAILED DESCRIPTION OF THE DRAWINGS

The present invention is directed to near-Earth space based communications system satellites in near-Earth, deep space stable-looking orbits and deep-space space based communications system spacecraft placed at strategic locations throughout the solar system to communicate with deep space spacecraft. Communications with a plurality of deep space spacecraft can be handled simultaneously by looking to various sections of deep space using a plurality of space based communications systems.

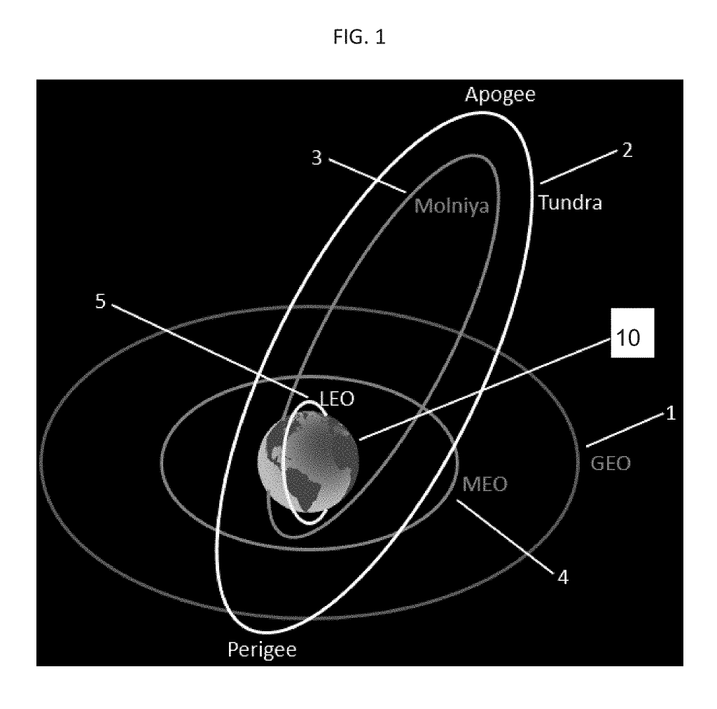

FIG. 1 illustrates a sample of available stable-looking orbits around the Earth 10. The near-Earth space based communications system satellites can be disposed as a payload on a satellite in the Geosynchronous Earth orbit (GEO) 1 or Equatorial orbit. Alternatively, the near-Earth space based communications system satellite can be disposed in the Tundra 2 or Molniya 3 orbits. Medium Earth orbit (MEO) 4 and low Earth orbit (LEO) 5 are illustrated for completeness of various Earth orbits. The characteristics of these orbits are described below:

| Orbit Definition | | Altitude Range, km | Period, hrs. |
|---|---|---|---|
| Low Earth Orbit (LEO) | | 150-1,000 | 1.5-1.8 |
| Medium Earth Orbit (MEO) | | 5,000-10,000 | 3.5-6 |
| Geosynchronous Earth Orbit | | 36,000 | 24 |
| Inclined | | | |
| Geostationary Earth Orbit (GEO) | | | |
| High Elliptical Orbit | Molniya | Perigree: ~500 | 12 |
| (HEO) | | Apogee: ~40,000 | |
| | Tundra | Perigree: ~24,000 | 24 |
| | | Apogee: ~48,000 | |

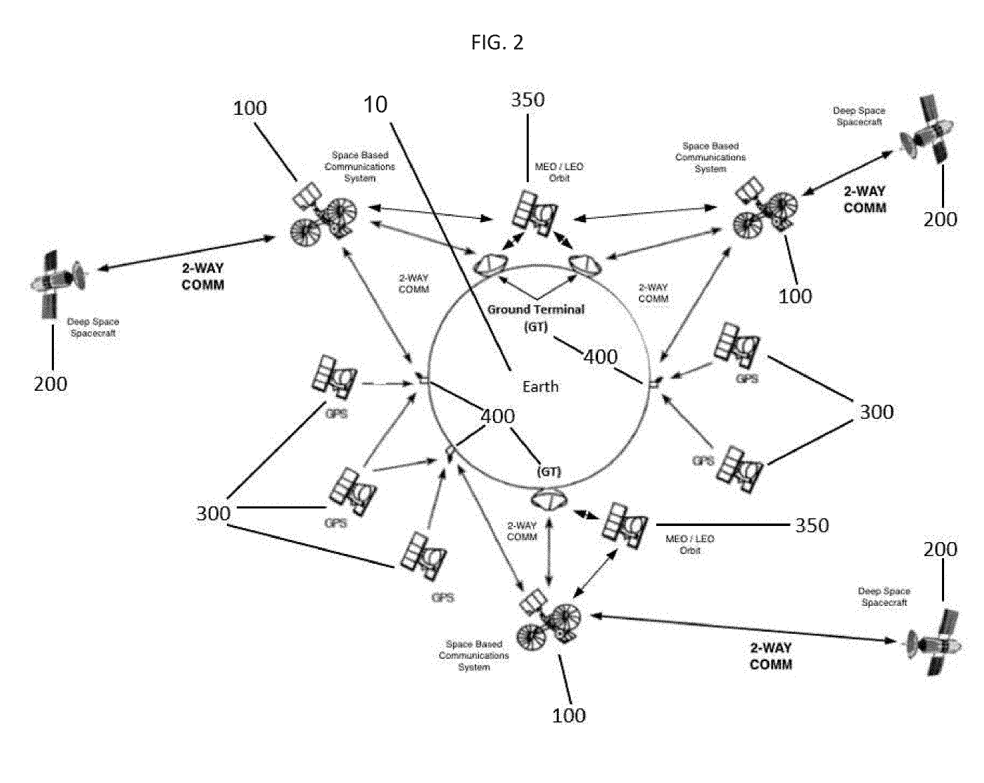

Deep space spacecraft 200 (FIG. 2) can be communicated with using a near-Earth space based communications system satellite 100 (FIG. 2) that has components including tunable receivers (receiver systems with pre-selector filters and variable LO ultra-stable frequency generators to achieve the proper IF frequency) and tunable transmitters, deep space oriented deployable antenna(s) with a plurality of antenna feeds. The near-Earth space based communications system satellite 100 may be located in a near-Earth 10 (FIG. 2), deep space stable-looking orbit. The near-Earth space based communications system satellite 100 communicates with a deep space spacecraft 200, stores the return (downlinked) telemetry transfer frames in existing on-board solid-state-recorders (for example) and communicates with specific receive infrastructure for distribution to an end user. The communication between the near-Earth space based communications system satellite 100 and different, multiple deep space spacecraft 200 can be performed by using tunable transmitters and receivers on different frequencies and/or by using polarization variation (switching from right-hand circular polarization (RHCP) to left-hand circular polarization (LHCP)) as required.

The near-Earth space based communications system satellite 100 location enables the allocation of the entire bandwidth of a space based communications system 100 to a deep space location of one or more deep space spacecraft 200. This use philosophy can be applied to multiple near-Earth space based communications system satellites 100 in Earth 10 orbit.

FIG. 2 illustrates near-Earth spaced based communications systems satellite 100 communicating with deep space spacecraft 200. The components of a near-Earth space based communications system satellite 100 can readily be interfaced with commercial communications satellites, leveraging existing infrastructure and providing a secondary revenue source to their original mission. As illustrated in FIG. 2, the near-Earth spaced based communications systems satellite 100 can conduct two-way communications with deep space spacecraft 200 and with GPS 300 and MEO/LEO commercial communication satellites 350 and ground terminals (GT) 400. Since commercial communication satellites 300 and 350 are on a regular launch cycle, they provide continual upgrade opportunities to stay ahead of the increasing number and complexity of civil and commercial deep space spacecraft 200.

The near-Earth space based communications system satellites 100 provide a number of benefits and advantages over current systems. Near-Earth space based communications system satellites 100 provide an offload benefit for deep space spacecraft 200 and DSN antennas, because deep space spacecraft 200 are capable of collecting and downloading more data than they currently do due to the scheduling and communication limits of DSNs. Currently, spacecraft operators coordinate their downlink schedule with the DSN based on DSN availability—not on the spacecraft's capability. Even with the restricted scheduling method of DSNs, they are oversubscribed for even collecting the minimum volume of required spacecraft data. Near-Earth space based communications system satellites 100 enable deep space spacecraft 200 operators to maximize their data collection and offload the oversubscribed DSNs.

Near-Earth space based communications system satellites 100 can be placed in orbits that support near continuous coverage of deep space locations, enabling the allocation of the entire bandwidth of a near-Earth space based communications system satellite 100 to a deep space location of one or more deep space spacecraft 200. Deep space locations such as Mars, the Moon, and the Lagrange Points can be covered 24 hours per day from Equatorial, Tundra, and Molniya orbits. The Tundra and Molniya orbits are also strategic for the commercial communication satellite operators expanding their fleets to provide greater service to populations that are not near the equator. The components of a near-Earth space based communications system satellite 100 can readily interface with single or multi-purpose satellites, leveraging existing infrastructure and providing a secondary revenue source to their original mission. As illustrated in FIG. 2, near-Earth spaced based communications systems satellites 100 can conduct two-way communications with deep space spacecraft 200 and with commercial communication satellites 300 and 350.

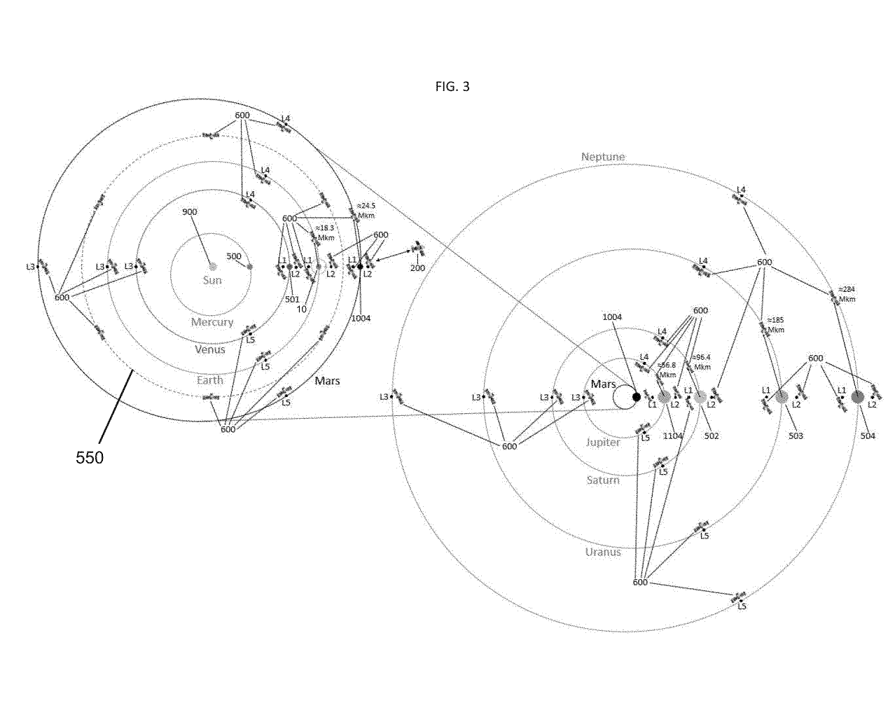

FIG. 3 illustrates deep-space spaced based communications systems spacecraft 600 placed at strategic locations throughout the solar system creating an internet-like system using relay spacecraft 600 as hubs for communication with deep space spacecraft 200 and Earth 10, including along orbital paths between planets and at Lagrange points L1, L2, L3, L4, and L5 between planets and the Sun 900. The components of a deep-space spaced based communications system spacecraft 600 can readily interface with single or multi-purpose satellites, leveraging existing infrastructure and providing a secondary revenue source to their original mission. As illustrated in FIG. 3, the deep-space spaced based communications system spacecraft 600 can conduct two-way communications with deep space spacecraft 200 and with near-Earth spaced based communications systems satellite 100. Deep-space spaced based communications system spacecraft 600 can also be strategically located between planetary orbits 550 (FIG. 3 dashed line between Earth 10 and Mars 1004), offset from the inner planet pair and at the same velocity as the inner planet or at a slower velocity than the inner planet but able to withstand the gravitational pull of the Sun 900. As planets move out of alignment, the range between them increases. These between planet deep-space spaced based communications systems spacecraft 600 or relay stations can ease the burden of requiring a high-power telecommunication subsystem on a deep space spacecraft 200 or assist in maintaining the highest data rate transmission possible back to Earth 10.

Space based communications between a deep space spacecraft 200 and Earth 10 can be performed with as many intermediate deep-space spaced based communications systems spacecraft 600 as necessary to reach Earth 10 with the highest bandwidth as possible and the lowest data latency as possible. Current deep space spacecraft 200 use fixed size reflector antennas for communication with Earth 10 through the DSN, with the size of the reflector based on the size of the spacecraft and overall mission system capability. Reflector size, telecommunications hardware and range to Earth 10 effect available data rate, and thus contact time and data latency. Using multiple deep-space spaced based communications systems spacecraft 600 with large deployable antennas, data rates can be increased and data communicated to Earth 10 faster. Deep-space spaced based communications systems spacecraft 600 locations will be easily known, like Earth 10, by being in relatively stable locations in the solar system respective to Earth 10 through on-board ephemeris files.

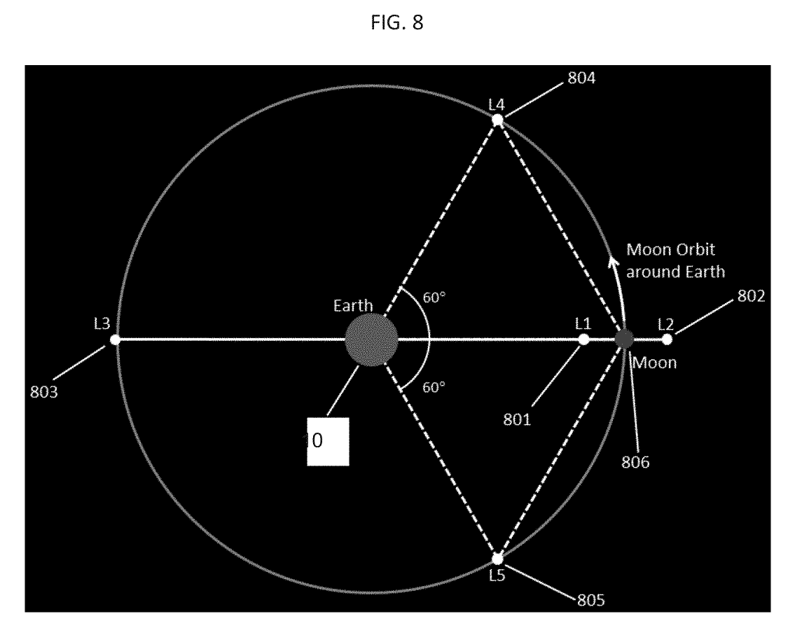

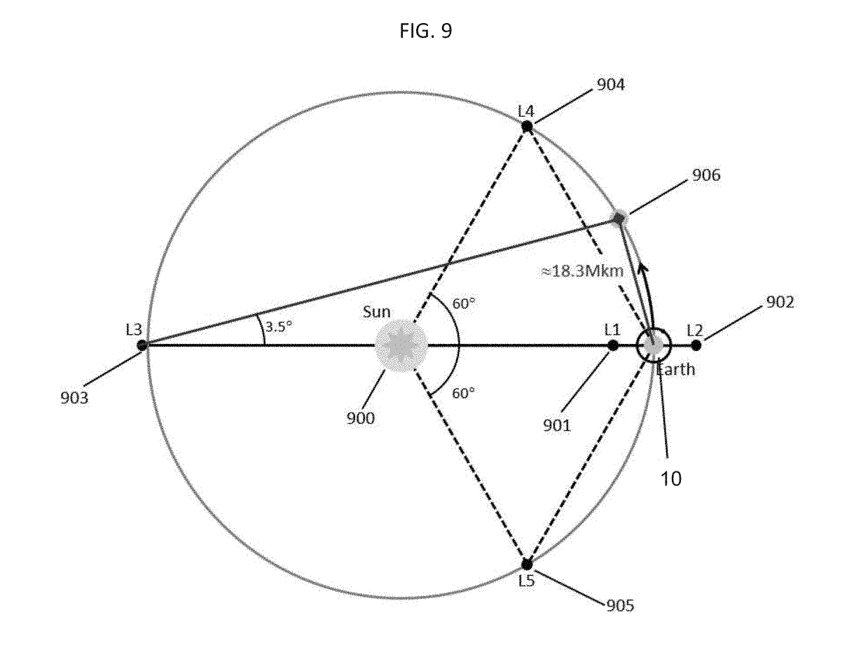

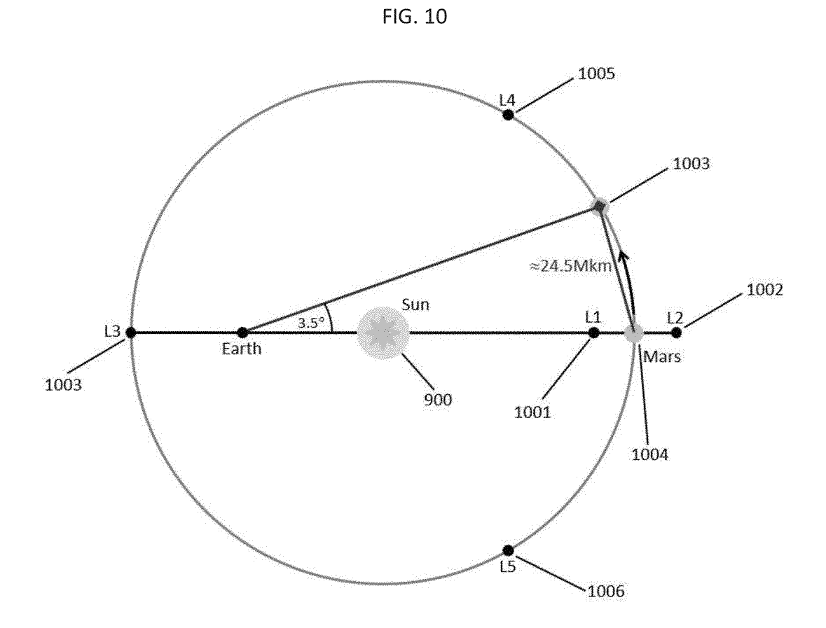

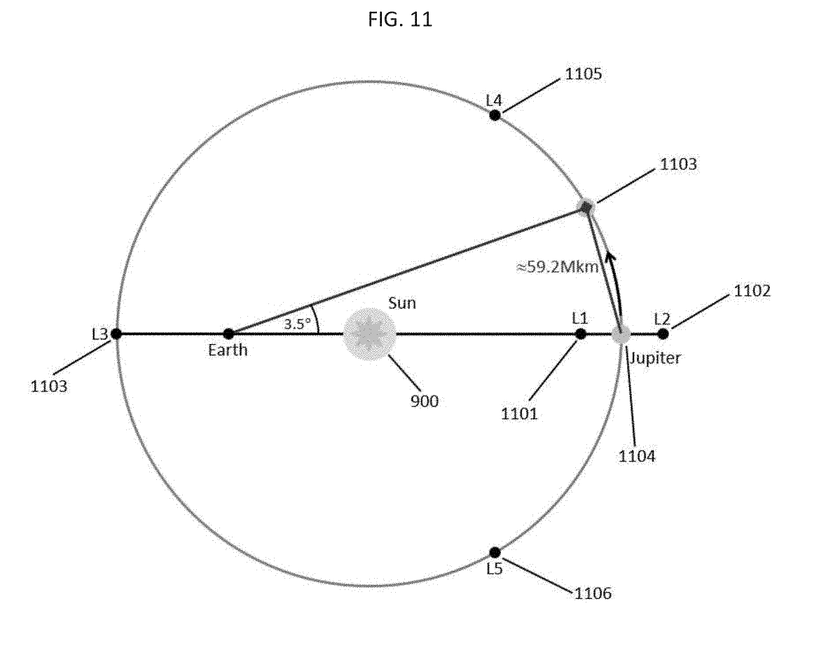

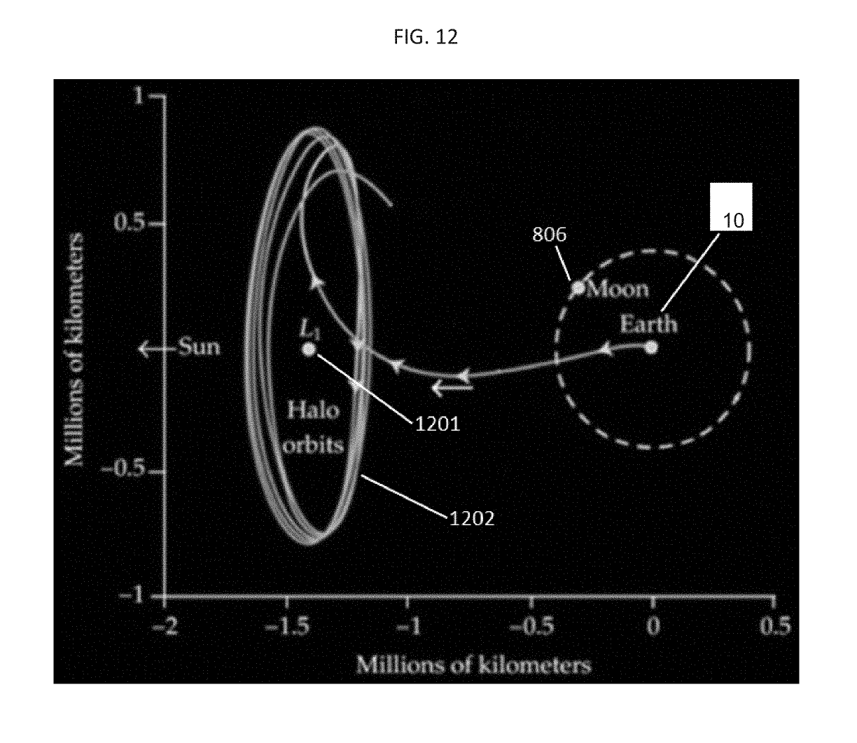

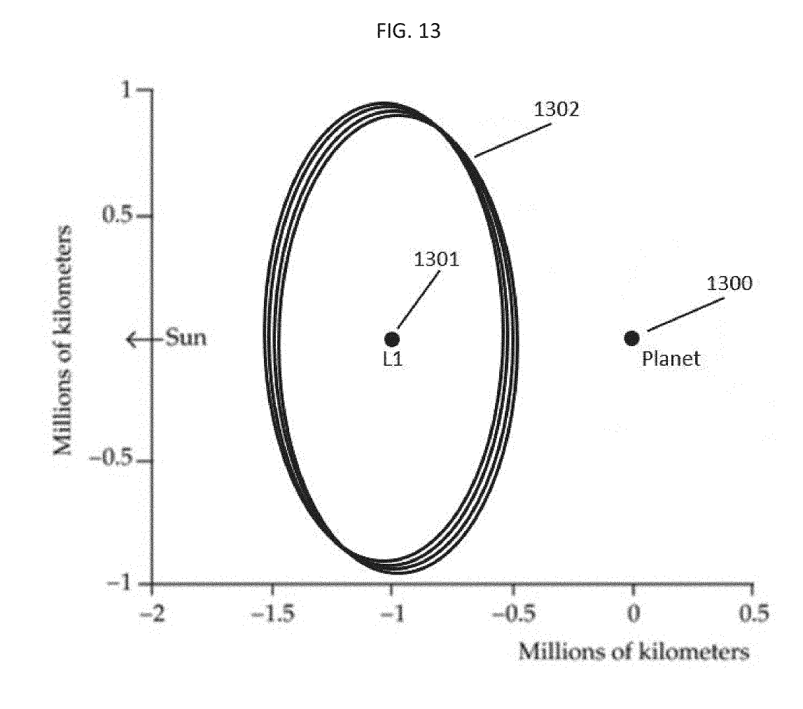

The near-Earth space based communication systems satellite 100 may include point-to-point radio frequency communication (RF), point-to-point laser communication (lasercom), or point-to-point x-ray communication (XCOM) to/from a deep space spacecraft 200 (deep space referring to any spacecraft outside of Geosynchronous orbit) to any of the following: (a) any Earth-based lasercom station, XCOM station, RF deep space network, e.g., NASA DSN, ESA DSN, JAXA DSN, ISRO DSN or communications satellite teleport 400 as shown in FIG. 2; (b) A near-Earth space based communication system satellite 100 in near-Earth Orbit, e.g., GEO, HEO, Tundra or Molniya orbits as shown in FIG. 1; (c) a deep-space spaced based communications system spacecraft 600 at Earth-Moon Lagrange Points (L1, L2, L3, L4 or L5) as shown in FIG. 2, FIG. 3, and FIG. 8; (d) a deep-space space based communications system spacecraft 600 at Sun-Earth Lagrange Points (L1, L2, L3, L4 or L5) as shown in FIG. 3 and FIG. 9 in a halo (FIG. 12) or large amplitude Halo orbit (example FIG. 13); (e) a deep-space space based communications system spacecraft 600 at Sun-Mars Lagrange Points (L1, L2, L3, L4 or L5) as shown in FIG. 3 and FIG. 10 in a large amplitude Halo orbit (example FIG. 13); (f) a deep-space space based communications system spacecraft 600 at other solar system Sun-planetary Lagrange Points (L1, L2, L3, L4 or L5) as shown in FIG. 3, FIG. 11, and FIG. 13 for Jupiter and other inner/outer planet communication.

For planets from Earth 10 and outside of Earth 10 orbit, the system may include a deep-space spaced based communications systems spacecraft 600 in a leading or trailing Sun-centered heliocentric orbit at a stationary distance from the planet to avoid the solar corona (3.5° from the solar corona) for any necessary Earth 10 contact during solar conjunction where signal degradation or loss would occur, or to be used as a relay station for further distance spacecraft.

Caution should be used with all planetary L4 and L5 Lagrange points, as they are gravitationally stable, and dust and asteroids can settle at these locations.

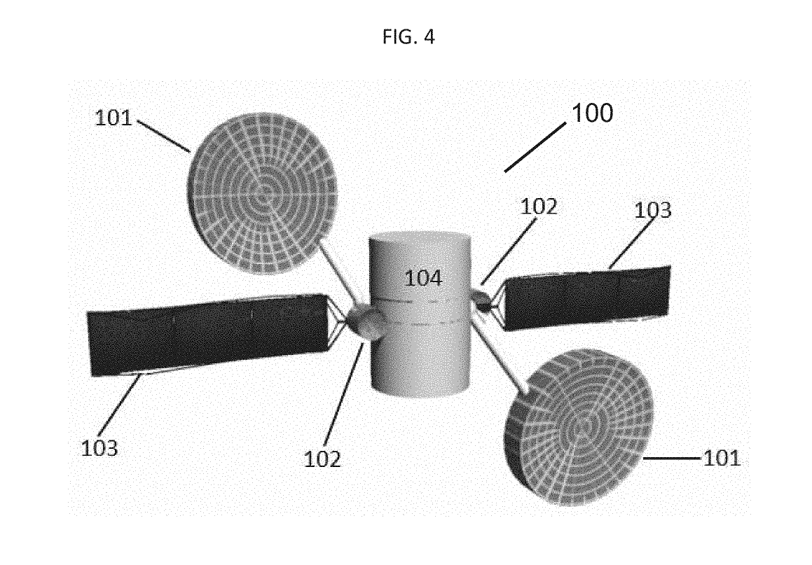

FIG. 4 illustrates a functional concept for a near-Earth space based communications system GEO satellite 100. Communications may be made through RF gimbaled/deployable antennas 101 and via lasercom/XCOM transmitter/receivers/detectors 102. The RF antennas 101 and lasercom/XCOM receivers 102 can be directly or indirectly attached to a solar array drive 104, which points a solar array 103 continually at the Sun 900, allowing the antennas 101 and receivers 102 to continually point at the Sun-Earth L1 or L2. This provides the link between the Sun-Earth L1/L2 Lagrange points and Earth 10.

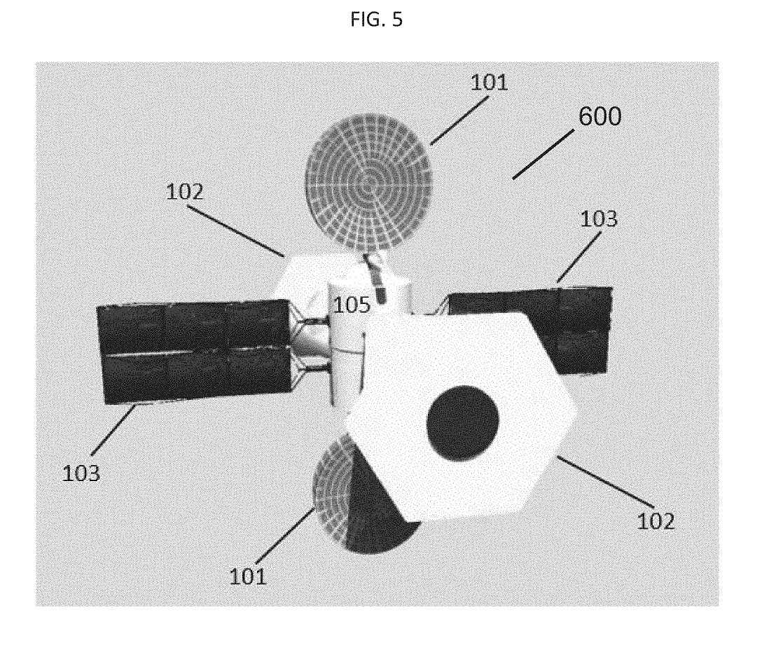

FIG. 5 illustrates a functional concept for a deep-space space based communications system spacecraft 600 (relay spacecraft) placed at strategic locations throughout the solar system. Communications may be made thru RF gimbaled/deployable antennas 101 and lasercom/XCOM receivers 102. The RF deployable antennas 101 may be independently gimbaled with one antenna pointing at Earth 10 and the other antenna pointing to a deep space spacecraft or another similar relay spacecraft. The lasercom/XCOM transmitters/receivers/detectors 102 on these spacecraft would be much larger than those described in FIG. 4 to allow for better signal reception. This provides the link between any deep space spacecraft to the Sun-Earth L1/L2 Lagrange points, near-Earth space based communications system satellites or directly to Earth 10. As a note, the gimbal on a gimbaled antenna allows the antenna to track the RF signal on any moving spacecraft or body to maintain signal lock, maintain highest possible signal strength and maintain the telecom link for best possible data rate and low bit errors.

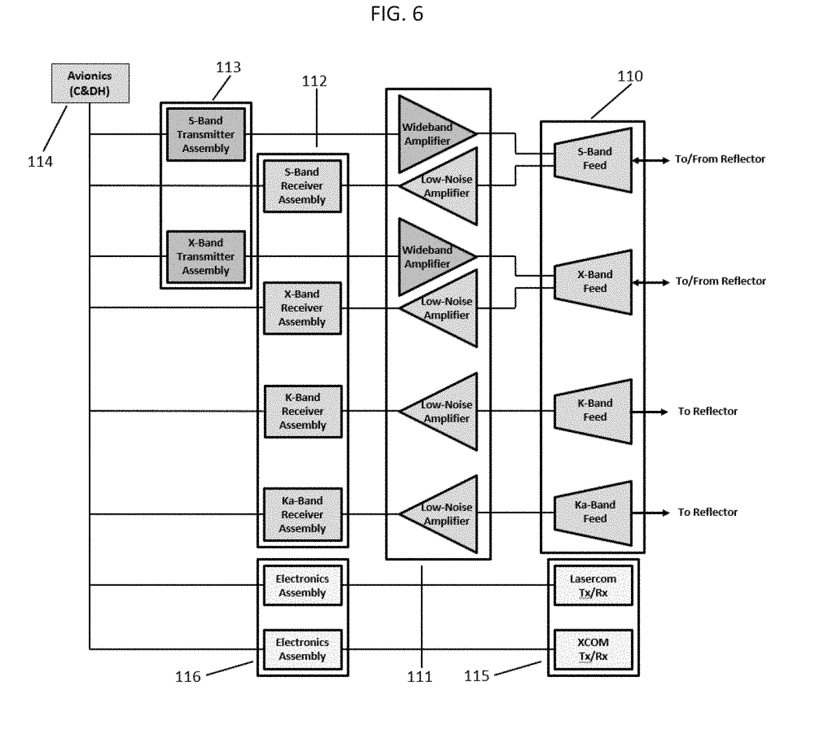

FIG. 6 illustrates a single deployable reflector with multiple antenna feeds 110 and associated hardware in a near-Earth space based communications system satellite 100 or a deep-space space based communications system spacecraft 600 to communicate with a deep space spacecraft 200. The antenna feeds 110 may include, for example, an S-band feed, an X-band feed, a K-band feed, and a Ka-band feed. Each of these antenna feeds 110 may be connected to one or more wideband and/or low noise amplifiers 111, which are connected to appropriate (e.g., S-band, X-band, K-band, and Ka-band) transmitter 113 and receiver assemblies 112. The system may also include data storage and a controller connected to the transmitter and receiver assemblies, illustrated as part of the Avionics hardware 114. This configuration can be duplicated for multiple reflectors.

Communication with deep space spacecraft 200 may be through transmitters and receivers, as shown in FIG. 6, that can be tuned to various channels as set forth by the International Telecommunication Union (ITU) for Category A (<2 Mkm from Earth) near-Earth (although many organizations consider the moon and beyond deep space) and Category B (>2 Mkm from Earth) deep space missions. As noted above, the system may include deployable antennas with multiple feeds that allow the transmission of the signal from the deep space spacecraft with the space based communications system. More than one antenna can be used at the same time to communicate with multiple spacecraft in the field of view as long as there is enough spectral bandwidth between frequencies.

FIG. 6 also illustrates laser communication and/or X-ray communication 115. This illustration aligns with FIGS. 4 and 5. Lasercom or XCOM transmitter and receiver 115 are controlled by their own separate electronics assemblies 116 that are controlled by flight software commands through the Avionics Subsystem 114. This set of hardware allows for very high data rate communication without any interference with RF communication bandwidth limitations. Hardware/components that may be used for the near-Earth space based communications system satellite will be of high TRL level and capable of interfacing to the communication satellite providers standard hardware, practices and interfaces with no or minimal modifications. Hardware/components that may be used for the deep-space space based communications system spacecraft 600 will be of high TRL level and capable of interfacing to the spacecraft providers standard hardware, practices and interfaces with no or minimal modifications. The goal is to achieve as close as possible to factory assembly-line integration.

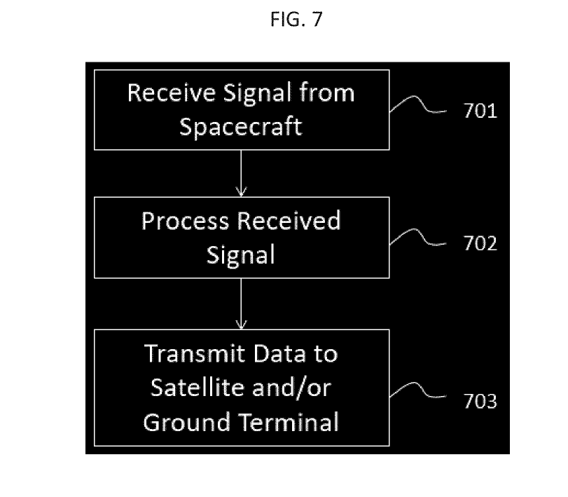

FIG. 7 illustrates a method of receiving a communication from a deep space spacecraft 200 and transmitting the communication to a satellite 100 or ground terminal 400. In step 701, the near-Earth space based communications system satellite 100 may receive a signal from any type deep space spacecraft 200. Alternatively, a near-Earth space based communications system satellite 100 can receive a signal from a near-Earth spacecraft. Orientation would not be an issue since the satellite 100 has gimbaled/deployable antennas. In particular, as shown in FIG. 6, an antenna of the near-Earth space based communications system satellite receives the signal and, via an appropriate antenna feed 110 based on the frequency of the signal, provides the received signal to an amplifier 111. For lasercom or XCOM 115, the signal from the detector may be provided to the electronics box 116. In step 702, the RF amplifier 111 amplifies the received signal and provides the amplified signal to an appropriate receiver assembly 112. All data from either RF, lasercom or XCOM may be then provided as a digital signal to the spacecraft Avionics hardware 114.

In step 703, the processed data may be transmitted to an end user, either directly to a ground terminal 400 on Earth 10 or via a satellite 100 orbiting Earth 10 that transmits the data to a ground terminal 400. Also, the amplified signal may be stored in the near-Earth space based communications system satellite's 100 data storage. Additionally, commands can be sent from the space based communications system satellite 100 to the deep space spacecraft 200 for start of data retrieval.

There may be provided a non-transitory computer-readable medium encoded with a computer program for communicating with deep space spacecraft. The term “computer-readable medium” as used herein refers to any medium that participates in providing instructions for execution. Common forms of computer-readable media include, for example, a floppy disk, a flexible disk, a hard disk, magnetic tape, any other magnetic medium, a CD-ROM, any other optical medium, punch cards, paper tape, any other physical medium with patterns of holes, a RAM, a PROM, an EPROM, a FLASH-EPROM, any other memory chip or cartridge, and any other non-transitory medium from which a computer can read.

FIG. 8 illustrates locations of deep-space space based communications system spacecraft 600 that communicate with deep space spacecraft 200 from Earth-Moon Lagrange points. All five Lagrange points are shown with appropriate ranges from either the Earth 10 or the Moon 806. It is noted that the L1 801, L2 802, and L3 803 Lagrange points are metastable so objects around these points slowly drift away into their own orbits around the Sun unless they actively maintain their positions, for example by using small periodic reaction control thrust. L4 804 and L5 805 are gravitationally stable in that objects there will orbit L4 804 and L5 805 with no assistance. The distances relevant to the Earth-Moon Lagrange points are described below:

Distances to Lagrange Points

| Earth to Moon | ≈384,300 km |
|---|---|
| Earth to L4/L5 - | ≈384,300 km |
| 804/805 | |
| Earth to L3 - 803 | ≈384,700 km |
| Earth to L1 - 801 | ≈326,200 km |
| Moon to L1 - 801 | ≈58,200 km |
| Moon to L2 - 802 | ≈64,700 km |
| Moon to L4/L5 - | ≈384,300 km |
| 804/805 | |

Lagrange points L1 and L2 are based on the following simplified equation, where R=range between the two main objects, M1 is the mass of the larger object and M2 is the mass of the smaller object:

$$r \approx {R}^{3} \sqrt{\frac{{M}_{1}}{3 {M}_{2}}}$$

Lagrange point L3 is calculated based on the following simplified equation:

$$r \approx R \frac{7 {M}_{2}}{12 {M}_{1}}$$

FIG. 9 illustrates locations of deep-space space based communications system spacecraft 600 that communicate with deep space spacecraft 200 from Sun-Earth Lagrange points. All five Lagrange points are shown with appropriate ranges from the Earth 10. It is noted that the L1 901, L2 902, and L3 903 Lagrange points are metastable so objects around these points slowly drift away into their own orbits around the Sun 900 unless they actively maintain their positions, for example by using small periodic reaction control thrust. L4 904 and L5 905 are gravitationally stable in that objects there will orbit L4 904 and L5 905 with no assistance. At least one Trojan asteroid is at each Earth L4 904 and L5 905 Lagrange points and possibility more. FIG. 9 also illustrates a deep-space space based communications system spacecraft 200 in a Sun-centered, Earth leading heliocentric orbit 906 that is relatively stationary at approximately 18.3 Mkm from Earth 10. This range from Earth 10 allows communication with a spacecraft at the L3 point 903 by having a line-of-sight angle of greater than 3.5° to limit any signal degradation due to the solar corona. The distances relevant to the Sun-Earth Lagrange points are described below, calculated in the same manner as described for the Earth-Moon Lagrange points above:

Distances to Lagrange Points

| | | |
|---|---|---|
| Earth to L1 - 901 | ≈−1,503,475.5 | km |
| Earth to L2 - 902 | ≈1,503,475.5 | km |
| Earth to L3 - 903 | ≈−299,198,132.8 | km |
| Earth to L4/L5 - | ≈149,597,870.7 | km |
| 904/905 | | |

FIG. 10 illustrates locations of deep-space space based communications system spacecraft 600 that communicate with deep space spacecraft 200 from Sun-Mars Lagrange points and from a space based communications system spacecraft 600 in a Sun-centered, Mars leading heliocentric orbit 1003 that is relatively stationary at approximately 24.5 Mkm 1003 from Mars 1004. This range from Mars 1004 allows communication with a spacecraft 600 to the Earth 10 from the far side of the Sun 900 by having a line-of-sight angle of greater than 3.5° to limit any signal degradation due to the solar corona. Sun-Mars L4 1005 and L5 1006 Lagrange points should be used with care since these points are known to contain Trojan asteroids. The distances relevant to the Sun-Mars Lagrange points are described below, calculated in the same manner as described for the Earth-Moon Lagrange points above:

Distances to Lagrange Points

| | | |
|---|---|---|
| Mars to L1 - 1001 | ≈−1,088,338 | km |
| Mars to L2 - 1002 | ≈1,088,338 | km |
| Mars to L4/L5 - | ≈227,620,000 | km |
| 1005/1006 | | |
| Sun to L3 - 1003 | ≈−227,620,043 | km |

The L1 1001 and L2 1002 orbit constellation of the FIG. 10 Sun-Mars Lagrange Points would require only two deep-space space based communications system spacecraft 600 for a fully operational constellation (each spacecraft sees approximately half of Mars 1004 at all times). The Sun 900 would always be visible to both L1 1001 and L2 1002 satellites, greatly simplifying system power requirements. Lander and orbiter pointing requirements are simple, given that the deep-space space based communications system spacecraft 600 would always be at the same relative distance from the Sun-Mars line. Interference from the constant solar radiation along the Sun-Mars line (solar exclusion zone that would be disruptive to communications) and certain Earth 10 viewing geometries has been compensated for by using a high amplitude halo orbit. A minor overlap in planetary coverage allows for continuous coverage of a Mars 1004 asset. A deep-space space based communications system spacecraft 600 may be also located, for example, in a Sun center heliocentric leading orbit 1003 at a stationary distance from Mars 1004 for communication with the any deep space spacecraft 200 or space based communications system spacecraft 600 behind the Sun 900 to Earth 10. The L3 1003 system may be made available as a relay station for other satellites.

FIG. 11 illustrates locations of deep-space space based communications system spacecraft 600 that communicate with deep space spacecraft 200 from Sun-Jupiter Lagrange points and from a deep-space space based communications system spacecraft 600 in a Sun-centered, Jupiter leading heliocentric orbit that is relatively stationary at approximately 56.8 Mkm 1103 from Jupiter 1104. This range from Jupiter 1104 allows communication with a spacecraft to the Earth 10 from the far side of the Sun 900 by having a line-of-sight angle of greater than 3.5° to limit any signal degradation due to the solar corona. Sun-Jupiter L4 1105 and L5 1106 Lagrange points should be used with care since these points are known to contain Trojan asteroids. The distances relevant to the Sun-Jupiter Lagrange points are described below, calculated in the same manner as described for the Earth-Moon Lagrange points above:

Distances to Lagrange Points

| | | |
|---|---|---|
| Jupiter to L1 - | ≈−53,295,971 | km |
| 1101 | | |
| Jupiter to L2 - | ≈53,295,971 | km |
| 1102 | | |
| Jupiter to L4/L5 | ≈778,570,000 | km |
| 1105/1106 | | |
| Sun to L3 - 1103 | ≈−779,003,539 | km |

The L1 1101 and L2 1102, orbit constellation of the FIG. 11 Sun 900 to Jupiter 1104 Lagrange Points requires only two deep-space space based communications system spacecraft 600 for a fully operational constellation (each spacecraft sees approximately half of Jupiter 1104 at all times). The Sun 900, using a large amplitude halo orbit, would always be visible to both L1 1101 and L2 1102 deep-space space based communications system spacecraft 600, greatly simplifying system power requirements. Orbiter pointing requirements are simple, given that the deep-space space based communications system spacecraft 600 would always be at the same relative distance from the Sun-Jupiter line. Interference from the constant solar radiation along the Sun-Jupiter line (solar exclusion zone that would be disruptive to communications) and certain Earth 10 viewing geometries have been compensated for by using a high amplitude halo orbit. A deep-space space based communications system spacecraft 600 may also be located, for example, in a sun center heliocentric leading orbit at a stationary distance from Jupiter 1104 for communication with the any deep space spacecraft or deep-space space based communications system spacecraft 600 offset from the Sun 900 to Earth 10 by 3.5°. The L3 1103 system may be made available as a relay station for other satellites. The configuration may be also usable for other outer planets and can be extend out to the outer boundary of the solar system.

FIG. 12 illustrates a halo orbit 1202 that would be used at the Sun-Earth L1 or L2 Lagrange points 1201 for a space based communications system spacecraft 600 station keeping near Earth 10. The illustration shown here is from the Genesis Mission. This figure would also be similar to the large amplitude halo orbit needed for other planet Lagrange points.

FIG. 13 illustrates a large amplitude halo orbit 1302 that would be used at the Sun-Earth L3, Sun-Mars or Sun-Jupiter L1, L2 or L3 Lagrange points 1301 for a space based communications system spacecraft 600 station keeping near a planet 1300. This type of orbit would be relatively slow in spacecraft velocity, where one orbit may take one Earth year. This allows the orbiting spacecraft to appear as a stationary point to any other spacecraft in communication. The large amplitude halo orbit may be larger than that shown depending on the specific location.

What is claimed:

1. A near-Earth satellite or deep-space spacecraft based communications system in a deep space stable-looking orbit for communicating with a deep space spacecraft, comprising:
a plurality of gimbaled/deployable antenna that communicates with the deep space spacecraft;
a plurality of antenna feeds that transmit RF signals to the deep space spacecraft within view of an antenna beam width and that receive RF signals from the deep space spacecraft within view of the antenna beam width;
a plurality of frequency tunable RF transmitter assemblies with high power, high bandwidth amplifiers that transmit simple uplink communication commands to the deep space spacecraft;
a plurality of frequency tunable RF receiver assemblies that receive low power downlink signals including data from the deep space spacecraft;
a plurality of lasercom receiver assemblies that receive low power, high data rate downlink (return) signals including data from the deep space spacecraft or space based communication systems spacecraft;
a plurality of lasercom receiver assemblies that receive low power, low data rate uplink (forward) signals including data to the deep space spacecraft or space based communication systems spacecraft;
a plurality of lasercom transmitter assemblies that transmit high power, high data rate downlink (return) signals including data from the deep space spacecraft or space based communication systems spacecraft;
a plurality of lasercom transmitter assemblies that transmit low power, low data rate uplink (forward) signals including data to the deep space spacecraft or space based communication systems spacecraft;
a data storage that stores the data downlinked from the deep space spacecraft; and
a transmitter that transmits the downlinked data to a ground terminal or satellite.
a plurality of XCOM assemblies for communication with deep space spacecraft or space based communication systems spacecraft;

2. The system of claim 1, further comprising:
a GPS terminal for communication with a GPS system allowing precision pointing for communication with the deep space spacecraft.

3. The system of claim 1, wherein the hardware associated with the deployable antenna is capable of changing polarizations.

4. A method for assembling a satellite based communications system for use in a deep space stable-looking orbit for communicating with a deep space spacecraft, the method comprising:
mounting a gimbaled/deployable antenna that communicates with the deep space spacecraft;
connecting to the antenna a plurality of antenna feeds that transmit RF signals to the deep space spacecraft or space based communication systems spacecraft within view of an antenna beam width and that receive RF signals from the deep space spacecraft or space based communication systems spacecraft within view of the antenna beam width;
connecting to the plurality of antenna feeds a plurality of frequency tunable RF transmitter assemblies with high power, high bandwidth amplifiers that transmit simple uplink communication commands to the deep space spacecraft or space based communication systems spacecraft;
connecting to the plurality of antenna feeds a plurality of frequency tunable RF receiver assemblies that receive low power downlink signals including data from the deep space spacecraft or space based communication systems spacecraft;
connecting to the plurality of frequency tunable RF transmitter assemblies and the plurality of frequency tunable RF receiver assemblies a data storage that stores the data downlinked from the deep space spacecraft or space based communication systems spacecraft;
connecting to the plurality of lasercom and/or XCOM systems to transmit/receive low data rate and high data rate signals with deep space or space based communication systems spacecraft and
connecting to the data storage a transmitter that transmits the downlinked data to a ground terminal or satellite.

5. The method of claim 4, further comprising:
connecting to the antenna a GPS terminal for communication with a GPS system allowing precision pointing for communication with the deep space spacecraft.

6. The method of claim 4, wherein the antenna is capable of changing polarizations.
